(19) United States
(12) Patent Application Publication
(10) Pub. No.: US 2003/0174774 A1
(43) Pub. Date: Sep. 18, 2003

(54) Method and system for transmitting digitized moving images from a transmitter to a receiver and a corresponding decoder

(76) Inventors: Elmar Mock, Lehmgrubenweg (CH); Elio Mariotto, Soluthurn (CH)

Correspondence Address: STAAS & HALSEY LLP, SUITE 700, 1201 NEW YORK AVENUE, N.W., WASHINGTON, DC, 20005, US

(21) Appl. No.: 10/332,346

(22) PCT Filed: Jul. 5, 2001
(86) PCT No.: PCT/DE01/02491

(30) Foreign Application Priority Data
Jul. 7, 2000 (DE) 10033110.6

(51) Int. Cl. H04N 7/12

(52) U.S. Cl. 375/240.11; 375/240; 375/240.21

(57) ABSTRACT

The invention relates to a method for transmitting digitized moving images (image data stream) from a transmitter to a receiver. The image data stream that is subdivided into priority classes is transmitted by means of a predetermined protocol to the receiver with the aid of an adaptation layer located at the transmitter. At an adaptation layer of the receiver, transmission errors are determined, subjected to an error processing and fed to an image decoder.

The invention relates to a method and system for transmitting digitized moving images from a transmitter to a receiver. The invention also relates to a corresponding image decoder.

A method for processing digitized image data, in particular an image compression method, is known to the person skilled in the art (see for example the image compression standards MPEG-2, MPEG-4 or H.26x).

In this connection, there is also a known method for transmitting the image data stream containing the sequence of digitized moving images from a transmitter to a receiver in such a way that the information having a high information content is transmitted first. This is done expediently through the use of so-called priority classes which are used to classify the information content of the sequence of moving images. Transmission of the image data in accordance with its priority classes thus makes it possible to transmit data with a high information content in the image data stream to the receiver first. Details can be found in publications [1], [2] or [3].

In addition, a so-called Realtime Transport Protocol (RTP) is known. RTP protocols are application-specific protocols for realtime applications such as audio and/or video, and make available functions for data type identification, packet numbering and time mark monitoring. These protocols are standardized by the Internet Engineering Task Force (IETF); examples for MPEG-1, MPEG-2 and H.263 are given in [4] or [5].

With regard to image processing, a method is also known which combines the individual image blocks to form macro blocks and in particular designates a plurality of contiguous macro blocks as a so-called “slice”. For example, a plurality of macro block rows or a graphical object related image segment can be combined to form a slice [6].

Now it is a problem associated with the prior art that during transmission over faulty channels a transmission error is not initially noticed by a decoder and the decoded error is propagated during the display of the sequence of moving images. This results in a significant impairment of quality in the displayed video image.

The object of the invention is almost completely to suppress error propagation in the video images.

This object is achieved in accordance with the features described in the independent claims. Developments of the inventions will also emerge from the dependent subclaims.

In order to achieve this object, firstly a method for transmitting digitized moving images from a transmitter to a receiver is set down, whereby the digitized moving images are present in the transmitter in the form of an image data stream. The image data stream is subdivided into priority classes. By using an adaptation layer in the transmitter, the image data stream subdivided into priority classes is transmitted to the receiver by means of a predefined protocol. Any transmission errors which may be present are determined by an adaptation layer in the receiver. The transmission errors detected are subjected to an error processing procedure in the receiver. The image data stream which has been subjected to error processing is fed to an image decoder (in the receiver).

The transmitted sequence of digitized moving images can thus be displayed at the receiver.

This method has the advantage that an “error processing” service is provided transparently for a standardized image decoder, which prevents an error on the transmission channel from being propagated in the display of the digitized moving images and thus prevents the aforementioned impairment of quality. Rather, the error processing service according to the above method ensures that an error of this type is detected and handled appropriately such that it does not result in the aforementioned propagation of errors in the moving images.

A particularly advantageous effect results from the combination of the subdivision into priority classes and the transmission employing the adaptation layer. The method thus ensures that the data in the image data stream is transmitted from the transmitter to the receiver with priority scheduling such that the data having the greatest information content arrives at the receiver first. This ensures that the moving images can initially be displayed at the receiver at a certain minimum quality level. The remaining data to be transmitted is used in particular to enable successive improvements in quality such that if a transmission error occurs at this time then at least the previously transmitted image data remains usable and the transmission error does not have any effect on the subsequently transmitted images.

It should be noted in this connection that preferably with effect from the occurrence of an error all image data from the image data stream which belongs specifically to this image within the sequence of moving images can be discarded. Accordingly, if this (discarded) image data is required for the reconstruction of an interimage, it is possible to specify that a reconstruction is not carried out on the basis of the obviously errored data. One possible way of performing error processing for each synchronized image consists in discarding the subsequent data for this image after the occurrence of an error. For example, data associated with a partition and not yet exhibiting any errors can be utilized for error processing and decoding up to the point where the error is detected. The error processing procedure can also consist in the errored data being discarded.

If a packet which contains a priority class or a part of a priority class is lost while it is being transmitted over a network, this will be noticed by the adaptation layer. As a result of this, a corresponding error processing procedure will be initiated. The loss of the packet will be noticed for example as a result of using the RTP protocol; the error processing is effected by discarding data.

In this situation in particular the method is based on packet losses; accordingly, a packet therefore either arrives or it has been lost during the transmission (in the network). In the latter case the information from this packet is not present. A possible error processing method could for example consist in an interpolation of motion vectors between a last motion vector class which can be decoded without error and a next motion vector class which can be decoded without error as a means of estimating the motion. In the event of the loss of a packet having a high information content, a complete image could also be discarded.

One development consists in the fact that a plurality of receivers is provided as the addressees for the image data stream.

Separation of the partitions by means of synchronization marks or a partition table is intended to ensure that following a transmission error the decoder can synchronize itself to the image data stream again after detection of a successive error. This forms part of the H.263 and MPEG-4 standard.

In the event of an error, data is discarded in particular up to the next detected partition boundary. By means of appropriate prioritization of the individual information content elements, the method should ensure that there is a far smaller probability of important information being lost than data (packets) having a low information content. The method thus ensures in particular that a certain minimum quality of image or of the sequence of moving images can be displayed.

A further development consists in the fact that sorting of the data for the moving images is performed in such a way on the basis of the priority classes that those data elements having the greatest information content are transmitted first within the image data stream from the transmitter to the receiver. As a result of this, as mentioned above, the method ensures that the data having the greatest information content (for each image in the sequence of moving images, in other words for every synchronizable unit) is transmitted first. Subsequently, data elements of decreasing importance are transmitted in each case (in staggered fashion), which ensures a successive improvement in the image quality. If the error should occur within these data elements, then the video image will still be recognizable with an adequate quality level, and the subsequent information element within the current synchronizable unit is discarded. Synchronizable unit here refers to the area between two synchronization points, starting from which the data in the image data stream is once again taken into consideration—even in the event of an error occurring.

A further development consists in the fact that the adaptation layer utilizes different protocols for transmitting from transmitter to receiver. In particular, it is possible for the adaptation layer to support either packet switching services or connection-oriented services. Advantageously, the adaptation layer uses the quality of service features of the respective transmission protocol.

In particular, it is advantageous if the adaptation layer is able to utilize a plurality of protocols at the same time or if the adaptation layer is able to utilize a plurality of channels of one or of different protocols at the same time.

One embodiment consists in the fact that the transmission error is determined as a result of the adaptation layer using an error-sensitive protocol. In particular, an error-sensitive protocol of this type is an RTP protocol. Every packet which can be identified on the basis of a sequence number can be regarded as error-sensitive in this case, in other words if a packet is lost the associated packet number is also missing. The incoming packet thus has a higher number than that which is actually expected. The error (in this case: packet loss) can thus be noticed.

In principle, however, any other protocol which at least ensures that transmission errors are noticed can also be used.

It is also an embodiment that the transmission is performed using a packet switching service and/or connection-oriented service.

A further embodiment is that the image decoder displays the contained moving images.

In particular, it is an advantage of the method described that a standard image decoder can be used for which the “error processing” service can be provided transparently. The functionality of the standard decoder is thus extended in such a way that it displays no further propagated transmission errors whatsoever. This is ensured by means of the described adaptation layer.

One development also consists in the fact that a group of contiguous macro blocks (slice) can be addressed by means of the header information in a priority class. This has the advantage in particular that a combination of a plurality of (successive) macro blocks (=slice) can be subdivided into priority classes as part of the image data stream. In this situation, the logical structure of the slice is also taken into consideration with regard to the sequence of the transmission of the image data elements within the image data stream. This can be done in different ways. One possible method consists in prefixing the slice information to the macro block type information for those blocks which are encompassed by the slice. Another possible method involves providing a slice table which permits an assignment of the macro block types or macro blocks to different slices. A third possible method consists in assigning the slice information directly to a subordinate priority class, for example to the DCT coefficients which are characteristic of the macro blocks which the slice encompasses.

One development in particular is that the image decoder is a standardized image decoder which operates in accordance with an MPEG standard or an H.26x standard.

Furthermore, in order to achieve the object, a method for decoding digitized moving images in a receiver is set down, whereby the digitized moving images are present in the form of an image data stream. The image data stream is subdivided into priority classes. Transmission errors are determined by means of an adaptation layer in the receiver. An error processing procedure is carried out in the receiver for the transmission errors and the transmitted image data stream which has been subjected to error processing is fed to an image decoder.

In addition, in order to achieve the object, an image decoder is described which has a processor unit and is designed in such a way that

a) the digitized moving images are present in the form of an image data stream,

b) the image data stream is subdivided into priority classes,

c) transmission errors can be determined by means of an adaptation layer in the receiver,

d) error processing can be performed in the receiver for the transmission errors, and

e) the transmitted image data stream which has been subjected to error processing can be fed to an image decoder.

Also, in order to achieve the object, a system for transmitting digitized moving images using a transmitter and a receiver is described, in which the digitized moving images are present as an image data stream in the transmitter. The transmitter subdivides the image data stream into priority classes. Using an adaptation layer, the transmitter transmits the image data stream which has been subdivided into priority classes to the receiver by means of a predefined protocol. The receiver uses an adaptation layer to determine transmission errors and carries out an error processing procedure for the determined errors. In the receiver the transmitted image data stream which has been subjected to error processing is fed to an image decoder.

The method for decoding digitized moving images is particularly suitable for implementation of one of the developments described above.

The image decoder and the system for transmitting digitized moving images are particularly suitable for implementation of the described methods or of one of the developments described above.

Embodiments of the invention will be described in the following with reference to the drawing.

In the drawing:

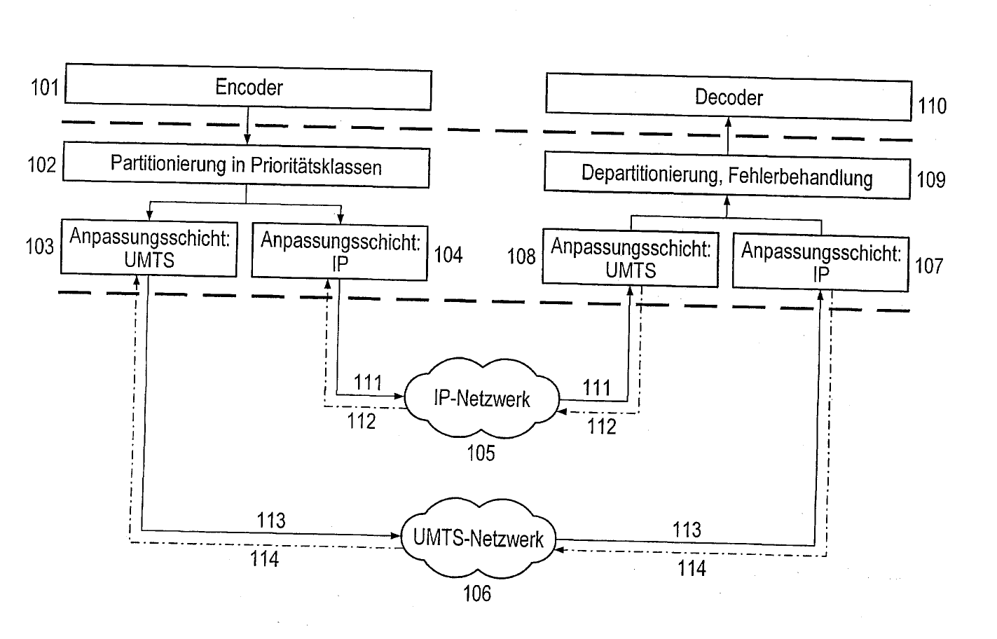

FIG. 1 shows an outline of a system for transmitting digitized moving images from a transmitter to a receiver.

FIG. 1 illustrates a system for transmitting digitized moving images using a transmitter and a receiver. The system, the image decoder and a method for transmitting digitized moving images from a transmitter to a receiver, and a method for performing the decoding, are described in the following.

FIG. 1 shows an encoder 101 for encoding moving images. The encoded moving images are to be transmitted (in compressed form if possible, minimizing resource usage in other words) to a decoder 110, whereby the decoder 110 preferably operates in accordance with a coding standard, for example MPEG-4 or H.263. To this end, an extension is provided in the protocol architecture which encompasses blocks 102 through 104 on the side of the encoder and blocks 107 through 109 on the side of the decoder. This extension to the protocol architecture serves the purpose of making available an additional service in a transparent manner for the decoder 110, namely that of providing an error-tolerant and error-processed image data stream. In this situation, it is advantageous on the one hand for the transmission to take place over the transmission channel (105 or 106) with regard to priority classes, in other words that information element having a high information content is transmitted first, and in addition the transmission errors on the channel are detected and processed in such a way that the decoder 110 does not contain any bit errors which are propagated over a sequence of moving images and thus result in a significant impairment in the quality of the displayed video image.

Accordingly, partitioning into priority classes is performed in a block 102 on the side of the encoder 101; that is, the image data stream is organized element by element into priority classes. Assuming an image data stream which originates for example from an H.26L image encoder and has the following structure

PSYNC|PTYPE|MB_TYPE1|MVD1|CBP1|LUM1|CHR_AC1|CHR_DC1|MB_TYPE2|MVD2|CBP2|LUM2|CHR_AC2|CHR_DC2 . . .

a partitioning into the following priority classes is performed:

1: PSYNC (“Picture Sync”, image synchronization)

PTYPE (“Picture Type”, image type)

2: MB_TYPE1 . . . MB_TYPEn (“macro block type”,

all the elements occurring in a frame/slice)

3: CBP1 . . . CBPn (“Coded Block Pattern”)

4: MVD1 . . . MVDn (“Motion Vector Difference”)

5: LUM1 . . . LUMn (“Luminance Coefficient”, luminance values)

6: CHR_DC1 . . . CHR_DCn (“DC Chrominance Coefficients”,

DC chrominance values)

7: CHR_AC1 . . . CHR_ACn (“AC Chrominance Coefficients”,

AC chrominance values)

The described priority classes 1 through 7 are shown by way of example, whereby the priority class 1 is the one having the highest priority. After partitioning of the image data stream into the priority classes (see block 102), a transmission by way of a (faulty) transmission channel is initiated in an adaptation layer (blocks 103 and 104). In FIG. 1, an adaptation layer for a UMTS network is shown in block 103 and an adaptation layer for an IP (Internet Protocol) network is shown in block 104. A major advantage now consists in the fact that, depending on the network used in each case, the special quality of service features of this network can be utilized. The quality of service features are notified to the adaptation layer by the network. In addition, on the side of the decoder 110 it is possible to notify the encoder 101 which adaptation layers are present in order that a corresponding utilization of the available networks takes place (see back channels 112 and 114). The adaptation layer packs the image data organized in priority classes into RTP packets and transmits these (over various paths, packet-oriented for example) to the respective adaptation layer (see blocks 107 and 108) on the side of the decoder 110. The image data streams are identified by the reference characters 111 and 113.

A packet sent in this manner by the adaptation layer has the following structure, for example:

1: PSYNC, PTYPE, MB_TYPE1 . . . MB_TYPEn, CBP1 . . . CBPn,

MVD1 . . . MVDn (priority classes 1 through 4))

2: LUM1 . . . LUMn (priority class 5)

3: CHR_DC1 . . . CHR_DCn (priority class 6)

4: CHR_AC1 . . . CHR_ACn (priority class 7)

This illustrates once again that the most important information for the respective image in the sequence of moving images is grouped together in priority classes 1 through 4; see explanation above. The brightness values (gray values, luminance values) are grouped together in priority class 5 and then are transmitted before the chrominance values (priority classes 6 and 7). When the decoder receives such a packet, it recognizes that an image is beginning, it recognizes the type of the image, whether objects are present in the image and, if so, where; it also recognizes the type of coding (DCT present in block or not) and the motion vector information.

Immediately afterwards the brightness values, in other words the real image information, are transmitted. The color information is transmitted following the brightness information; if necessary, the image is also recognizable without the color information.

The transmission over the network takes place by utilizing the network-specific features; an Internet Protocol network and a UTMS network are shown by way of example in FIG. 1. Each of these networks can be subject to disruptions, whereby packet losses can occur. The adaptation layer (see blocks 107 and 108) on the side of the decoder detects such packet losses. Block 109 deals with departitioning, in other words the restoration of the image data stream by division of the priority classes, and performs error processing for the information which has been lost. Finally, the result is passed to the decoder 110. The decoder 110 can thus be a standardized image decoder, the service for partitioning and departitioning into priority classes and the described error processing procedure are provided transparently for the standardized decoder 110.

In particular, each low priority class exhibits dependencies on a higher priority class. If data from the higher priority class is lost, data from the priority class lying beneath, which is dependent on elements in the lost class, can also no longer be evaluated unless the lost information can be predicted from preceding images (“error concealment”). This prediction is all the more successful the more correlated (but the less efficient in terms of coding) the individual image information elements are.

A special feature consists in the fact that a grouping of a plurality of successive macro blocks (slice) can also be taken into consideration in a partitioned image data stream. In this situation, it is advantageously set down below how on the one hand the slice remains addressable in the partitioning method described above and how on the other hand the smallest possible amount of storage space is required for the addressing.

A normal arrangement of slice headers in image data streams (without partitioning) has the following format:

|PSYNC|PTYPE|

SLICE|MBTYPE1|DCT-Coeff1|MBTYPE2|DCT-Coeff2|

SLICE|MBTYPE1| . . .

where

SLICE=Slice header

SLICETABLE=Slice addressing in the form of a table

DCT-Coeff=All DCT coefficients in one macro block

When partitioning is performed, the opportunity actually presents itself to specify the slice headers in such a way that all the macro block types contained in the slice appear after them.

|PSYNC|PTYPE|

|SLICE|MBTYPE1|MBTYPE2|

|SLICE|MBTYPE3|MBTYPE4| . . . →

→DCT-Coeff1|DCT-Coeff2|DCT-Coeff3|DCT-Coeff4| . . .

In this situation, the slice header information is incorporated in priority class 2 of the above example (macro block type).

Alternatively, the addressing of the slice header can take place in the form of a table, whereby the elements of the table denote which macro blocks belong to which slice (column/row assignment). This type of slice addressing has the following format:

|PSYNC|PTYPE|

|SLICETABLE|MBTYPE1|MBTYPE2|MBTYPE3|MBTYPE4| . . .

A further alternative consists in the fact that the addressing of the slice header takes place within the actual image data, in other words within the DCT coefficients. In this case, the slice information is associated for example with the chrominance values, in other words priority class 5 according to the above arrangement.

An example of this is shown in the following:

|PSYNC|PTYPE|

|MBTYPE1|MBTYPE2|MBTYPE3|MBTYPE4| . . . →

→|SLICE|DCT-Coeff1|DCT-Coeff2|

|SLICE|DCT-Coeff3|DCT-Coeff4| . . . |

When slice addressing by way of a table or within the macro block type partition is employed, it is possible to make significant storage space savings. In addition, when agreement is reached on a particular type of addressing, a transparent and efficient conversion can be performed for the decoder 110 in the adaptation layer of the receiver.

Literature:

[1] J. D. Villasenoro: “Proposed Draft Text for the H.263 Annex V Data Partitioned Slice Mode”, ITU, Study Group 16, Video Experts Group, Document: Q15-I-14, Red Bank Meeting, Oct. 18-21, 1999

[2] H. -D. Cho, Y. -S. Saw, “A New Error Resilient Coding Method using Data Partitioning with Reed-Solomon Protection”, ITU, Study Group 16, Video Experts Group, Document: Q15-H-25, Berlin Meeting, Aug. 3-6, 1999

[3] M. Lutrell, “Simulating Results for Modified Error Resilient Syntax with Data Partitioning and RVLC”, ITU, Study Group 16, Video Experts Group, Document: Q15-F-29, Seoul Meeting, Nov. 2-6, 1998

[4] D. Hofmann, G. Fernando: “RTP Payload Format for MPEG1/MPEG2 Video”, IETF Doc. RFC 2250, http://www.ietf-org/rfc.html.

[5] C. Zhu. “RTP Payload Format for H.263 Video Streams”, IETF Doc. RFC 2190, http://www.ietf.org/rfc.html.

[6] ITU Recommendation H.263 Annex K.

1. Method for transmitting digitized moving images from a transmitter to a receiver,
a) whereby the digitized moving images are present as an image data stream in the transmitter,
b) whereby the image data stream is subdivided into priority classes,
c) whereby an adaptation layer in the transmitter is used to transmit the image data stream subdivided into priority classes to the receiver by means of a plurality of protocols for different networks,
d) whereby an adaptation layer in the receiver is used to determine transmission errors,
e) whereby an error processing procedure is performed in the receiver for the transmission errors, and
f) whereby the transmitted image data stream which has been subjected to error processing is fed to an image decoder.

2. Method according to claim 1,
whereby a plurality of receivers is provided as the addressees for the image data stream.

3. Method according to claim 1 or 2,
whereby the priority classes are used to perform sorting of the data for the moving images in such a way that those data elements having the greatest information content are transmitted first within the image data stream from the transmitter to the receiver.

4. Method according to one of the preceding claims,
whereby the adaptation layer provides the service for transmission between transmitter and receiver by taking into consideration predefined quality of service features for the transmission.

5. Method according to one of the preceding claims,
whereby transmission errors are determined as a result of the adaptation layer using an error-sensitive protocol.

6. Method according to claim 5,
whereby the error-sensitive protocol is an RTP protocol.

7. Method according to one of the preceding claims,
whereby the transmission takes place over one or more radio interfaces.

8. Method according to one of the preceding claims,
whereby the transmission is handled as a packet switching service and/or connection-oriented service.

9. Method according to one of the preceding claims,
whereby the image decoder displays the moving images contained in the transmission.

10. Method according to one of the preceding claims,
whereby a group of contiguous macro blocks can be addressed by means of the header information in a priority class.

11. Method according to claim 10,
whereby the header information for the group of contiguous macro blocks is grouped together in the form of a table.

12. Method according to one of the preceding claims,
whereby the image decoder is a standardized image decoder operating in accordance with an MPEG standard or an H.26x standard.

13. Method for decoding digitized moving images, encoded according to one of the preceding claims, in a receiver,
a) whereby the digitized moving images are present as an image data stream,
b) whereby the image data stream is subdivided into priority classes,
c) whereby an adaptation layer in the receiver is used to determine transmission errors in a plurality of protocols for different networks,
d) whereby an error processing procedure is performed in the receiver for the transmission errors, and
e) whereby the transmitted image data stream which has been subjected to error processing is fed to an image decoder.

14. Image decoder,
having a processor unit, which is designed in such a way that
a) the digitized moving images are present in the form of an image data stream,
b) the image data stream is subdivided into priority classes,
c) an adaptation layer in the receiver is used to determine transmission errors in a plurality of protocols for different networks,
d) an error processing procedure can be performed in the receiver for the transmission errors, and
e) the transmitted image data stream which has been subjected to error processing is fed to an image decoder.

15. System for transmitting digitized moving images using a transmitter and a receiver,
a) whereby the digitized moving images are present as an image data stream in the transmitter,
b) whereby the transmitter subdivides the image data stream into priority classes,
c) whereby the transmitter uses an adaptation layer to transmit the image data stream subdivided into priority classes to the receiver by means of a plurality of protocols for different networks,
d) whereby the receiver uses an adaptation layer to determine transmission errors in the protocols for the different networks,
e) whereby the receiver performs an error processing procedure for the transmission errors, and
f) whereby the transmitted image data stream which has been subjected to error processing is fed to an image decoder.
